(19) United States
(12) Patent Application Publication
(10) Pub. No.: US 2022/0061588 A1
(43) Pub. Date: Mar. 3, 2022

(54) ROTARY-PAN PIZZA OVEN

(71) Applicant: Dongguan HaoHong Outdoor Products Technology Co., Ltd., Dongguan City (CN)

(72) Inventor: MengWei YAN, Dongguan City (CN)

(21) Appl. No.: 17/060,096

(22) Filed: Oct. 1, 2020

(30) Foreign Application Priority Data
Aug. 31, 2020 (CN) 202021863920.3
Aug. 31, 2020 (CN) 202021863991.3

(51) Int. Cl. A47J 37/06

(52) U.S. Cl. CPC A47J 37/0658; A47J 37/0664

(57) ABSTRACT

A rotary-pan pizza oven includes a rack, a pan mechanism, a burning mechanism and an oven body. The pan mechanism includes a rotary pan, a grill rack, a shaft, a connecting part, and a driving device. The driving device is fixed to the bottom of the rack by the connecting part; the shaft is passed through the rack and rotatably connected to the driving device; an upper end of the shaft is rotatably connected to the grill rack; and the rotary pan is mounted onto the grill rack. The oven body is disposed at an upper surface of the rack; the grill rack is disposed in the oven body; both front and rear ends of the oven body have an opening; the burning mechanism is disposed at a front end of the oven body and communicated with the oven body; and the burning mechanism has a vent.

### FIELD OF INVENTION

The present invention relates to the technical field of food baking technology, in particular to a rotary-pan pizza oven.

### BACKGROUND OF INVENTION

### Description of the Related Art

As pizza was introduced to China, more and more people love this food, and the pizza production technique is becoming more mature. Many people make pizzas at home, and general household or pizza producers usually use a pizza oven to make pizzas.

Conventional pizza ovens basically use electricity, gas, or wood for burning and have the disadvantages of slow heating, uneven heat circulation, and inconvenient feeding. In addition, the conventional pizza oven needs to turn the pizza from time to time while baking the pizza in order to achieve a uniform heating effect, and it takes too much time and effort and may even end up with a burned pizza.

### SUMMARY OF THE INVENTION

Therefore, it is a primary objective of the present invention to overcome the drawbacks of the prior art by providing a rotary-pan pizza oven, and the pizza oven has a driving device for driving a grill rack to link and rotate a rotary pan, so as to overcome the uneven heating problem of the pan, and the pizza oven also has a burning mechanism capable of adding or refilling fuel quickly, and providing the effects of fast heating and balanced heat loop, so as to make the pizza production more flexible and improve the efficiency of the pizza production.

To achieve the aforementioned and other objectives, the present invention discloses a rotary-pan pizza oven comprising a rack, a pan mechanism, a burning mechanism and an oven body, characterized in that the pan mechanism comprises a rotary pan, a grill rack, a shaft, a connecting part, and a driving device, and the driving device is fixed and coupled to the bottom of the rack by the connecting part, and the shaft is passing through the rack and rotatably coupled to the driving device, and the shaft has an upper end rotatably coupled to the grill rack, and the rotary pan is fixed and mounted onto the grill rack; the oven body is disposed on an upper surface of the rack, and the grill rack is disposed in the oven body, and both front and rear ends of the oven body have an opening, and the burning mechanism is installed at the front end of the oven body, and the burning mechanism and the oven body are communicated with each other, and the burning mechanism has a vent.

Further, the pizza oven comprises a digital control box and a temperature probe, and the digital control box is installed at the rack and disposed on a side of the driving device, and the temperature probe is installed in the oven body, and the temperature probe is communicated with the digital control box.

Further, the burning mechanism comprises an upper box, a lower box, a feeding cover, a storage drawer and a grid carrier, and the upper box has an upper end opening formed thereon, and the lower box has an opening separately formed at both front and rear ends thereof, and the storage drawer is mounted into the front end opening of the lower box, and the grid carrier is installed at an upper end of the storage drawer, and the upper box is installed at an upper end of the lower box, and the upper box and the lower box are communicated with each other, and the feeding cover is installed at the upper end opening of the upper box.

Further, the oven body comprises an upper casing and a bottom plate disposed at a lower end of the upper casing, and the middle of the bottom plate has a perforation, and the bottom plate is disposed at an upper surface of the rack, and an upper end of the shaft is passed through the perforation.

Further, the upper casing comprises an outer shell layer and an inner shell layer, and a shell cavity is formed between the outer shell layer and the inner shell layer.

Further, the pizza oven comprises a chimney, and an upper surface of the outer shell layer has an interface penetrating through the outer shell layer, and the chimney is disposed at the interface, and the chimney and the shell cavity are communicated with each other.

Further, the oven body has a cover plate disposed at a rear end thereof and provided for sealing.

Further, the front end of the oven body and the rear end opening of the lower box have a deflector.

Further, the burning mechanism has an insulation shell disposed on an outer side thereof and coupled to the outer shell layer.

Further, the pan mechanism further comprises a cooling shell disposed on an outer side of the driving device.

Further, the burning mechanism comprises a gas pipe, a connecting pipe, an electromagnetic ignition mechanism, an exhaust pipe, a jet combustion pipe, and at least one igniter, and the gas pipe is coupled to a gas input end of the connecting pipe, and the exhaust pipe is coupled to a gas output end of the connecting pipe, and the electromagnetic ignition mechanism is installed at an upper end of the connecting pipe for controlling a gas flow rate of the exhaust pipe, and an outlet end of the exhaust pipe is communicated with the jet combustion pipe, and the igniter is coupled to the electromagnetic ignition mechanism, and the jet combustion pipe is fixed and installed on a side of the pan mechanism.

Further, the pizza oven comprises a partition plate disposed between the burning mechanism and the oven body, and the partition plate has a through hole formed thereon, and the exhaust pipe is passed through the through hole and communicated with the jet combustion pipe.

Further, the jet combustion pipe has a plurality of gas jet holes formed on a sidewall which is disposed on a side of the pan mechanism.

Further, the rack has an air-exchange hole formed on an upper surface thereof and disposed under the jet combustion pipe.

The present invention has the following advantageous effects: The pizza oven of the present invention includes the driving device to effectively drive the grill rack to link and rotate the rotary pan to avoid the uneven heating problem of the pan, and the burning mechanism is provided to achieve the effects of adding or refilling fuel quickly, expediting the heating, and improving the pizza production efficiency.

### BRIEF DESCRIPTION OF THE DRAWINGS

FIG. 1 is a first perspective view of an embodiment of the present invention;

FIG. 2 is a second perspective view of an embodiment of the present invention;

FIG. 3 is a first exploded view of an embodiment of the present invention;

FIG. 4 is a second exploded view of an embodiment of the present invention;

FIG. 5 is a schematic view of a pan mechanism combined with a rack in accordance with an embodiment of the present invention;

FIG. 6 is an exploded view of a pan mechanism in accordance with an embodiment of the present invention;

FIG. 7 is a front view of an oven body in accordance with an embodiment of the present invention;

FIG. 8 is a side view of an oven body in accordance with an embodiment of the present invention;

FIG. 9 is a first perspective view of another embodiment of the present invention;

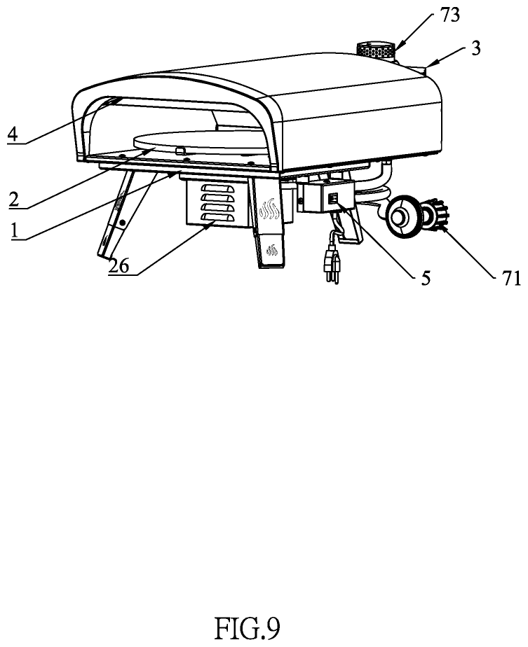

FIG. 10 is a second perspective view of another embodiment of the present invention;

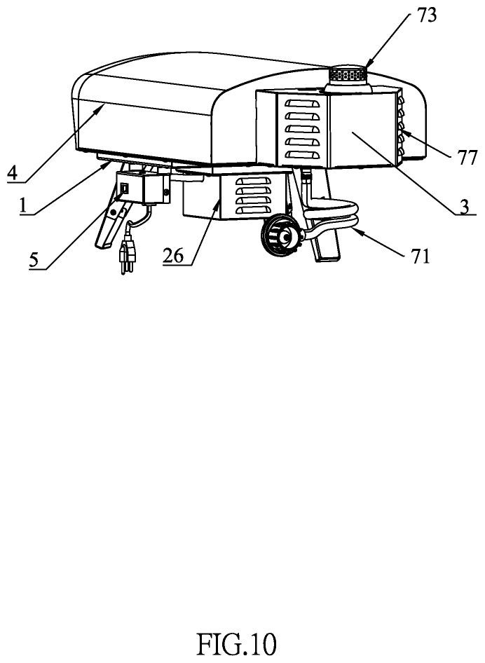

FIG. 11 is a first exploded view of another embodiment of the present invention;

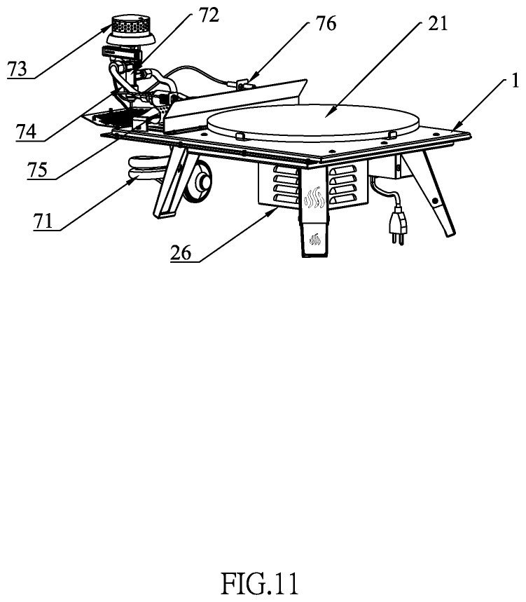

FIG. 12 is a second exploded view of another embodiment of the present invention;

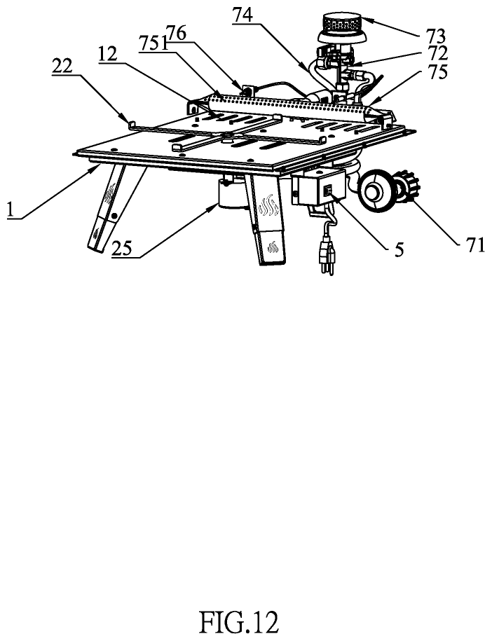

FIG. 13 is a schematic view of an oven body in accordance with another embodiment of the present invention;

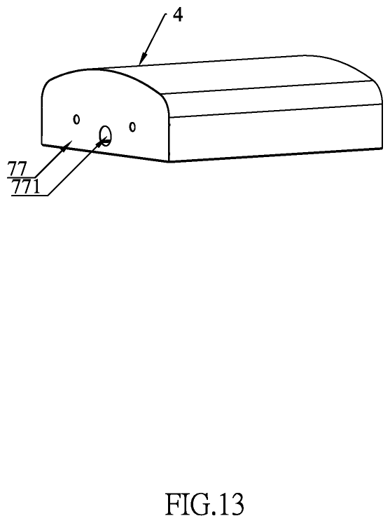

Brief Description of Numerals Used in the Drawings: 1—Rack, 12—Air-exchange hole, 2—Pan mechanism, 21—Rotary pan, 22—Grill rack, 23—Shaft, 24—Connecting part, 25—Driving device, 26—Cooling shell, 3—Burning mechanism, 31—Upper box, 32—Lower box, 33—Feeding cover, 34—Storage drawer, 341—Vent, 35—Grid carrier, 36—Insulation shell, 4—Oven body, 41—Upper casing, 411—Outer shell layer, 4111—Interface, 412—Inner shell layer, 413—Shell cavity, 42—Bottom plate, 421—Perforation, 43—Cover plate, 44—Deflector, 5—Digital control box, 6—Chimney, 71—Gas pipe, 72—Connecting pipe, 73—Electromagnetic ignition mechanism, 74—Exhaust pipe, 75—Jet combustion pipe, 751—Gas jet hole, 76—Igniter, 77—Partition plate, 771—Through hole.

### DESCRIPTION OF THE PREFERRED EMBODIMENTS

The present invention will become clearer in light of the following detailed description of an illustrative embodiment of this invention described in connection with the drawings. It is intended that the embodiments and figures disclosed herein are to be considered illustrative rather than restrictive.

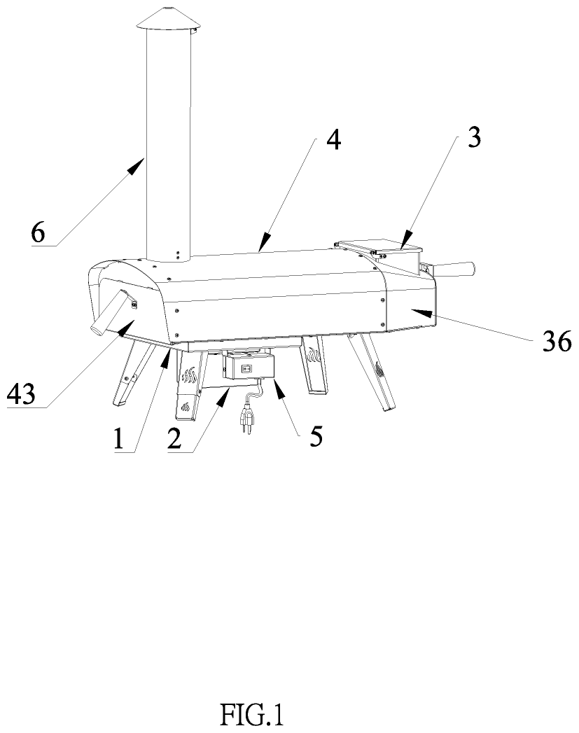

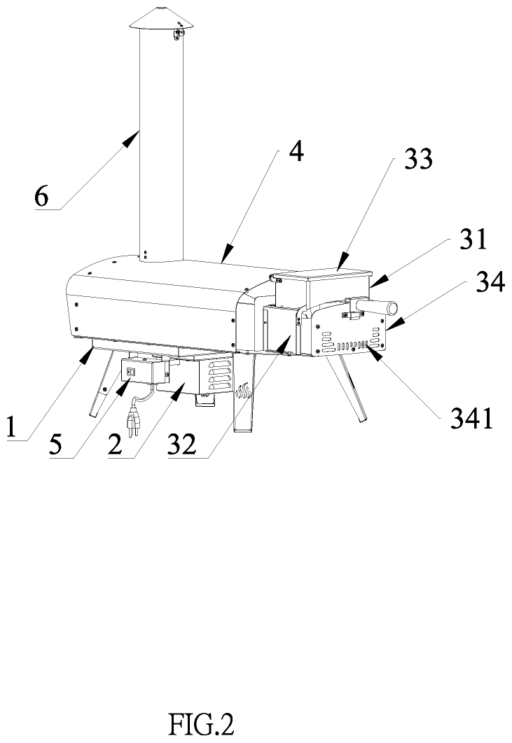

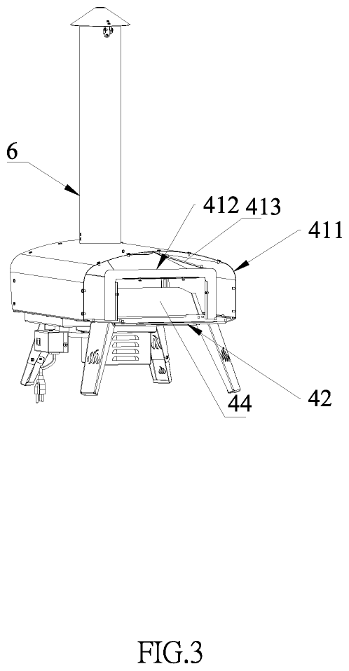

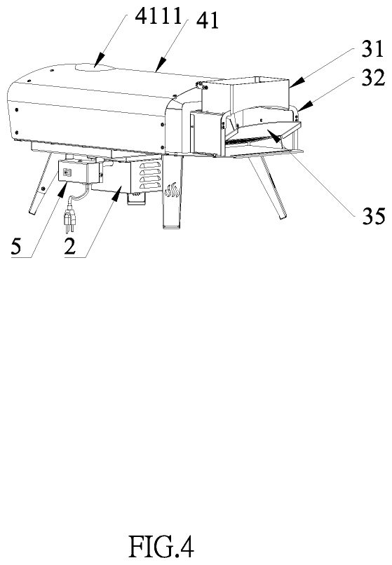

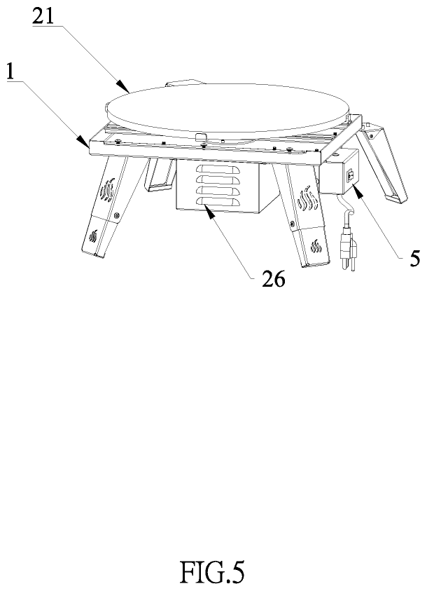

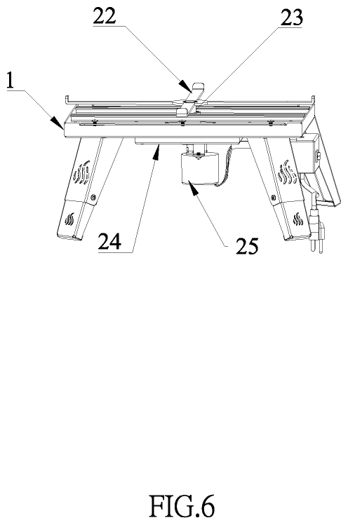

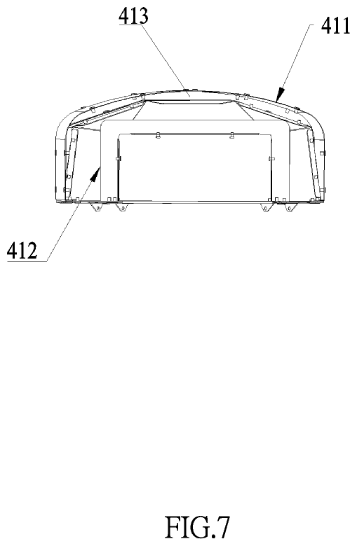

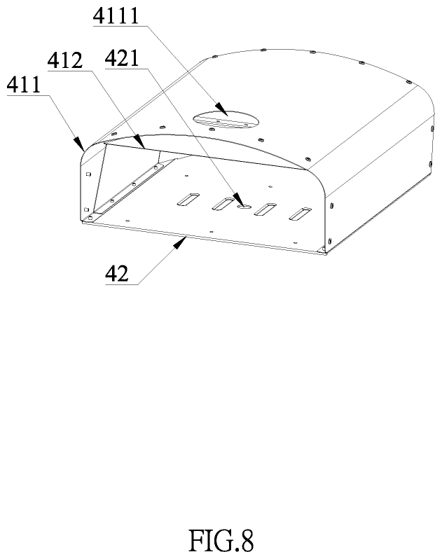

With reference to FIGS. 1 to 8 for a rotary-pan pizza oven of the present invention, the rotary-pan pizza oven comprises a rack 1, a pan mechanism 2, a burning mechanism 3 and an oven body 4, characterized in that the pan mechanism 2 comprises a rotary pan 21, a grill rack 22, a shaft 23, a connecting part 24, and a driving device 25, wherein the driving device 25 is coupled to the bottom of the rack 1 by the connecting part 24, and the shaft 23 is passed through the rack 1 and rotatably coupled to the driving device 25, and an upper end of the shaft 23 is rotatably coupled to the grill rack 22, and the rotary pan 21 is fixed and mounted onto the grill rack 22; the oven body 4 is installed on an upper surface of the rack 1, and the grill rack 22 is disposed in the oven body 4, and both front and rear ends of the oven body 4 have an opening, and the burning mechanism 3 is installed at a front end of the oven body 4 and communicated with the oven body 4, and the burning mechanism 3 has a vent 341. The pizza oven further comprises a digital control box 5 and a temperature probe, and the digital control box 5 is installed at the rack 1 and disposed on a side of the driving device 25, and the temperature probe is installed in the oven body 4 and communicated with the digital control box 5.

In this embodiment, the pizza oven uses the driving device 25 to drive the grill rack 22 to link and rotate the rotary pan 21 effectively, so as to avoid the uneven heating problem of the pan, and the connecting part 24 is provided for fixing the driving device 25 to the bottom of the rack 1, so as to ensure that the driving device 25 can drive the rotary pan 21 to rotate stably, and also ensure the baking efficiency of pizzas and the quality of pizzas in the oven, and the grill rack 22 so configured makes the removal, cleaning, or replacement of the rotary pan 21 easy and convenient. In addition, the temperature probe (not shown in the figure) is installed in the oven body 4 and operated very well with a control program of the digital control box 5 in order to adjust the rotating speed of the driving device 25, so that the rotary pan 21 can be quickly and uniformly heated to reduce the pizza baking time and ensure the quality of the produced pizza. In addition, the burning mechanism 3 has the effects of adding or refilling fuel quickly, expediting the heating, and improving the pizza production efficiency.

In this embodiment, the burning mechanism 3 comprises an upper box 31, a lower box 32, a feeding cover 33, a storage drawer 34 and a grid carrier 35. The vent 341 is installed on a sidewall of the storage drawer 34, and the upper box 31 has an upper end opening, and both front and rear ends of the lower box 32 have an opening, and the storage drawer 34 is mounted into the front end opening of the lower box 32, and the grid carrier 35 is installed at an upper end of the storage drawer 34, and the upper box 31 is disposed at an upper end of the lower box 32 and communicated with the lower box 32, and the feeding cover 33 is installed at the upper end opening of the upper box 31.

In this embodiment, the burning mechanism 3 is configured with an upper box 31 and a lower box 32 to facilitate the process of separating pellet fuels or charcoal fuels and dust after combustion by the grid carrier 35, so that the pellet fuel or charcoal fuel can be burned at the upper box 31, and the dust or combustion residue is connected in the storage drawer 34 through the grid carrier 35, so as to ensure the hygiene issues during the pizza baking process, and the dust or combustion residue in the storage drawer 34 can be removed or dumped anytime. Such arrangement can clean the oven body 4 of the pizza oven without requiring the tedious operation of stopping the operation of the oven, and thus can improve the production efficiency. In addition, a feeding cover 33 is added and installed to the upper box 31, and the feeding cover 33 can be covered after the fuel is added or refilled, and such arrangement can avoid heat loss and improve the heating rate of the oven body 4.

In this embodiment, the oven body 4 comprises an upper casing 41 and a bottom plate 42 installed at the lower end of the upper casing 41, and a perforation 421 is formed at the middle of the bottom plate 42, and the bottom plate 42 is disposed on an upper surface of the rack 1, and an upper end of the shaft 23 is passed through the perforation 421. The upper casing 41 has an outer shell layer 411 and an inner shell layer 412, and a shell cavity 413 is formed between the outer shell layer 411 and the inner shell layer 412. The pizza oven further comprises a chimney 6, and the upper surface of the outer shell layer 411 has an interface 4111 penetrating through the outer shell layer 411, and the chimney 6 is installed at the interface 4111 and communicated with the shell cavity 413.

In this embodiment, the upper casing 41 is configured to have an outer shell layer 411 and an inner shell layer 412, and a shell cavity 413 is formed between the outer shell layer 411 and the inner shell layer 412, and such arrangement facilitates the shell cavity 413 coupled to the chimney 6 to separate and guide the smoke produced after by combustion of the pellet fuel out from the oven body 4, so as to avoid the smoke from being in contact with the pizza in the oven body 4. The inner shell layer 412 provides a very good heating and heat preserving effect, and can effectively utilize the remaining heat of the smoke. In addition, the outer shell layer 411 is made of an insulating material and has the effects of maintaining good thermal insulation, avoiding temperature loss inside the oven body 4, and preventing the high temperature at the outer surface of the oven body 4 from burning the user.

In this embodiment, the rear end of the oven body 4 has a cover plate 43 for the purpose of sealing.

In this embodiment, the cover plate 43 installed at the rear end of the oven body 4 is provided for sealing the oven body 4 after a pizza to be baked is put into the oven body 4, so as to ensure the temperature inside the oven body 4 during a baking process, and such arrangement can improve the work efficiency of the pizza oven, and the quality and taste of the baked pizza.

In this embodiment, an insulation shell 36 is installed on an outer side of the burning mechanism 3 and coupled to the outer shell layer 411; a front end of the oven body 4 and a rear end opening of the lower box 32 have a deflector 44; and the pan mechanism 2 further comprises a cooling shell 26 installed on an outer side of the driving device 25.

In this embodiment, the insulation shell 36 of the burning mechanism 3 has good thermal insulation and heat preservation effects and can lower a user's risk of being burned by contacting the burning mechanism 3 accidentally. The deflector 44 is provided for guiding the smoke produced by the burning mechanism 3 to the shell cavity 413 and discharge the smoke to the outside through the chimney 6. The cooling shell 26 installed on the outer side of the driving device 25 has the effects of reducing the heat produced by the driving device 25 during the operation of the oven, avoiding the driving device 25 from being burned or damaged by the high temperature generated by the driving device 25 in long-hour operations, so as to improve the overall performance of the pizza oven.

In another embodiment, the burning mechanism 3 uses gas for burning. The burning mechanism 3 comprises a gas pipe 71, a connecting pipe 72, an electromagnetic ignition mechanism 73, an exhaust pipe 74, a jet combustion pipe 75 and at least one igniter 76. The gas pipe 71 is coupled to a gas input end of the connecting pipe 72, and the exhaust pipe 74 is coupled to a gas output end of the connecting pipe 72, and the electromagnetic ignition mechanism 73 is installed at an upper end of the connecting pipe 72 for controlling a gas flow rate of the exhaust pipe 74, and an outlet end of the exhaust pipe 74 is communicated with the jet combustion pipe 75, and the igniter 76 is coupled to the electromagnetic ignition mechanism 73, and the jet combustion pipe 75 is fixed and installed to a side of the pan mechanism 2; a partition plate 77 is installed between the burning mechanism 3 and the oven body 4, and the partition plate 77 has a through hole 771 formed thereon, and the exhaust pipe 74 is passed through the through hole 771 and communicated with the jet combustion pipe 75.

In this embodiment, the pizza oven comes with the driving device 25 capable of effectively driving the grill rack 22 to link and rotate the rotary pan 21 and avoid the uneven heating problem of the pan. The gas pipe 71 and the external gas storage device (not shown in the figure) allows users to change gas conveniently, and the electromagnetic ignition mechanism 73 provides a quick ignition, while controlling the air flow passing through the exhaust pipe 74, so as to achieve the effects of adjusting a flame size, expediting the heating, controlling the temperature. When the electromagnetic ignition mechanism 73 is pressed, the igniter 76 installed at the jet combustion pipe 75 ignites the gas, so that the invention has the advantages of fast heating and balanced heat loop, and makes the pizza production more flexible and improves the pizza production efficiency. In addition, a temperature probe (not shown in the figure) installed in oven body 4 can be operated very well with a control program of the digital control box 5 to adjust the rotating speed of driving device 25, so that the rotary pan 21 can be heated quickly and uniformly, and the pizza baking time can be shortened, and the quality of the produced pizza can be ensured. This invention can make the pizza production more flexible and improve the pizza production efficiency.

In this embodiment, the jet combustion pipe 75 has a plurality of gas jet holes 751 formed on a sidewall on a side of the pan mechanism 2.

In this embodiment, a plurality of gas jet holes 751 is formed on a sidewall on a side of the pan mechanism 2 having the jet combustion pipe 75, and such arrangement facilitates an even dispersion of the flame and achieves quick heating of the inner shell layer 51 of the oven body 4, fast heating, and balanced heat loop, so as to make the pizza production more flexible and improve the pizza production efficiency.

In this embodiment, an air-exchange hole 12 is formed on an upper surface of the rack 1 and disposed under the jet combustion pipe 75.

In this embodiment, an air-exchange hole 12 is formed on a bottom surface of the rack 1 and disposed at the jet combustion pipe 75, and jet combustion pipe 75 can provide sufficient oxygen during the combustion to ensure the gas fuel can be fully combusted and further improve the utilization of the fuel.

While the invention has been described by means of specific embodiments, numerous modifications and variations could be made thereto by those skilled in the art without departing from the scope and spirit of the invention set forth in the claims.

What is claimed is:

1. A rotary-pan pizza oven, comprising a rack, a pan mechanism, a burning mechanism and an oven body, characterized in that the pan mechanism comprises a rotary pan, a grill rack, a shaft, a connecting part, and a driving device, and the driving device is fixed and coupled to the bottom of the rack by the connecting part, and the shaft is passing through the rack and rotatably coupled to the driving device, and the shaft has an upper end rotatably coupled to the grill rack, and the rotary pan is fixed and mounted onto the grill rack; the oven body is disposed on an upper surface of the rack, and the grill rack is disposed in the oven body, and both front and rear ends of the oven body have an opening, and the burning mechanism is installed at the front end of the oven body, and the burning mechanism and the oven body are communicated with each other, and the burning mechanism has a vent.

2. The rotary-pan pizza oven as claimed in claim 1, further comprising a digital control box and a temperature probe, and the digital control box being installed at the rack and disposed on a side of the driving device, and the temperature probe being installed in the oven body, and the temperature probe being communicated with the digital control box.

3. The rotary-pan pizza oven as claimed in claim 1, wherein the burning mechanism comprises an upper box, a lower box, a feeding cover, a storage drawer and a grid carrier, and the upper box has an upper end opening formed thereon, and the lower box has an opening separately formed at both front and rear ends thereof, and the storage drawer is mounted into the front end opening of the lower box, and the grid carrier is installed at an upper end of the storage drawer, and the upper box is installed at an upper end of the lower box, and the upper box and the lower box are communicated with each other, and the feeding cover is installed at the upper end opening of the upper box.

4. The rotary-pan pizza oven as claimed in claim 1, wherein the oven body comprises an upper casing and a bottom plate disposed at a lower end of the upper casing, and the middle of the bottom plate has a perforation, and the bottom plate is disposed at an upper surface of the rack, and an upper end of the shaft is passed through the perforation.

5. The rotary-pan pizza oven as claimed in claim 4, wherein the upper casing comprises an outer shell layer and an inner shell layer, and a shell cavity is formed between the outer shell layer and the inner shell layer.

6. The rotary-pan pizza oven as claimed in claim 5, further comprising: a chimney, and an upper surface of the outer shell layer having an interface penetrating through the outer shell layer, and the chimney being disposed at the interface, and the chimney and the shell cavity being communicated with each other.

7. The rotary-pan pizza oven as claimed in claim 1, wherein the oven body has a cover plate disposed at a rear end thereof and provided for sealing.

8. The rotary-pan pizza oven as claimed in claim 3, wherein the front end of the oven body and the rear end opening of the lower box have a deflector.

9. The rotary-pan pizza oven as claimed in claim 6, wherein the burning mechanism has an insulation shell disposed on an outer side thereof and coupled to the outer shell layer.

10. The rotary-pan pizza oven as claimed in claim 1, wherein the pan mechanism further comprises a cooling shell disposed on an outer side of the driving device.

11. The rotary-pan pizza oven as claimed in claim 1, wherein the burning mechanism comprises a gas pipe, a connecting pipe, an electromagnetic ignition mechanism, an exhaust pipe, a jet combustion pipe, and at least one igniter, and the gas pipe is coupled to a gas input end of the connecting pipe, and the exhaust pipe is coupled to a gas output end of the connecting pipe, and the electromagnetic ignition mechanism is installed at an upper end of the connecting pipe for controlling a gas flow rate of the exhaust pipe, and an outlet end of the exhaust pipe is communicated with the jet combustion pipe, and the igniter is coupled to the electromagnetic ignition mechanism, and the jet combustion pipe is fixed and installed on a side of the pan mechanism.

12. The rotary-pan pizza oven as claimed in claim 11, further comprising a partition plate disposed between the burning mechanism and the oven body, and the partition plate having a through hole formed thereon, and the exhaust pipe being passed through the through hole and communicated with the jet combustion pipe.

13. The rotary-pan pizza oven as claimed in claim 11, wherein the jet combustion pipe has a plurality of gas jet holes formed on a sidewall which is disposed on a side of the pan mechanism.

14. The rotary-pan pizza oven as claimed in claim 1, wherein the rack has an air-exchange hole formed on an upper surface thereof and disposed under the jet combustion pipe.
